(19) United States
(12) Patent Application Publication
(10) Pub. No.: US 2008/0008191 A1
(43) Pub. Date: Jan. 10, 2008

(54) Network System, Image-Processing Device, Image-Processing Method, Computer-Readable Medium, Computer Data Signal, and Network-Setting Device

(75) Inventor: Hiroyuki Eguchi, Kanagawa (JP)

Correspondence Address: GAUTHIER & CONNORS, LLP, 225 FRANKLIN STREET, SUITE 2300, BOSTON, MA, 02110, US

(73) Assignee: FUJI XEROX CO., LTD., Tokyo (JP)

(21) Appl. No.: 11/564,363

(22) Filed: Nov. 29, 2006

(30) Foreign Application Priority Data
Jul. 7, 2006 (JP) 2006-187936

(51) Int. Cl. H04L 12/56

(52) U.S. Cl. 370/397

(57) ABSTRACT

A network system includes a terminal on a network, and a network-setting device, wherein the terminal has a temporary address acquisition unit that acquires a temporary address from an address assignment device; a notification sending unit that sends a notification, including the acquired temporary address, to the network-setting device; and a fixed address acquisition unit that acquires a fixed address to be assigned to the terminal, the fixed address being provided by the network-setting device in response to the notification, and the network-setting device has a fixed-address-providing unit that provides the fixed address, which is to be assigned to the terminal, to the terminal identified by the temporary address included in the notification in response to the notification.

### PRIORITY INFORMATION

This application claims priority from Japanese Patent Application No. 2006-187936, filed on Jul. 7, 2006.

### BACKGROUND

1. Technical Field

The present invention relates to a network system, an image-processing device, an image-processing method, a computer-readable medium, a computer data signal, and a network-setting device.

2. Related Art

According to a known technology, a temporary IP address is automatically assigned to a DHCP client by means of a DHCP (Dynamic Host Configuration Protocol) server.

### SUMMARY

According to one aspect of the present invention, there is provided, a network system including: a terminal on a network, and a network-setting device, wherein the terminal has: a temporary address acquisition unit that acquires a temporary address from an address assignment device; a notification sending unit that sends a notification, including the acquired temporary address, to the network-setting device; and a fixed address acquisition unit that acquires a fixed address to be assigned to the terminal, the fixed address being provided by the network-setting device in response to the notification, and the network-setting device has a fixed-address-providing unit that provides the fixed address, which is to be assigned to the terminal, to the terminal identified by the temporary address included in the notification in response to the notification.

### BRIEF DESCRIPTION OF THE DRAWINGS

Exemplary embodiment of the present invention will be described in detail based on the following figures, wherein:

FIG. 1 is a block diagram showing the general configuration of a network system in an exemplary embodiment;

FIG. 2 is a block diagram showing the functional configuration of an image-processing device and an agent;

FIG. 3 is a flowchart showing the operation procedure of the image-processing device; and

FIG. 4 is a flowchart showing the operation procedure of the agent.

### DETAILED DESCRIPTION

An exemplary embodiment of the present invention will be described with reference to the attached drawings.

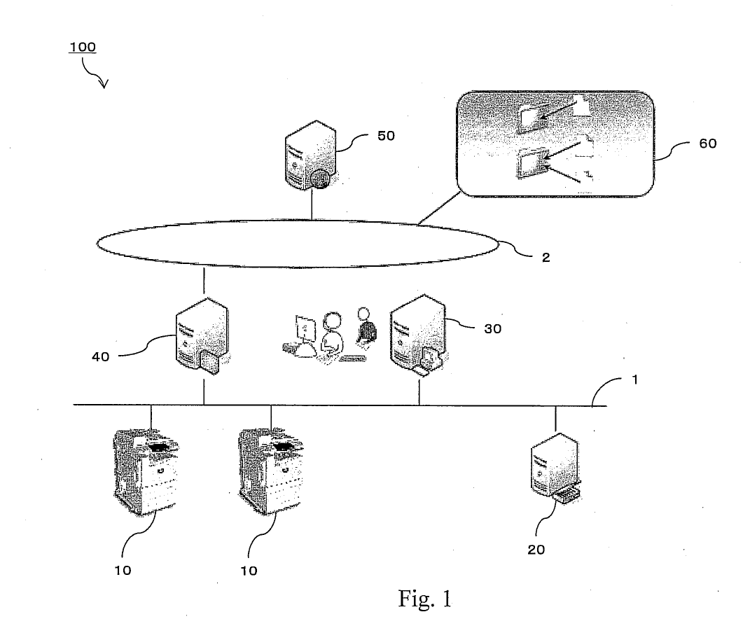

FIG. 1 is a block diagram showing the general configuration of a network system 100 in this exemplary embodiment.

As shown in FIG. 1, the network system 100 includes one or more image-processing devices 10 that is an example of a terminal on a network, a DHCP server 20 that functions as an address assignment device, and an agent 30 that works as a network-setting device. Those devices are on an intranet 1.

The image-processing device 10 is a device having a printer function, a scanner function, a copy function, and/or a facsimile function. In this exemplary embodiment, the image-processing device 10 is a Multi Function Peripheral (MFP) that has two or more of the functions described above (including at least the printer function).

The DHCP server 20 is a device that automatically assigns a temporary IP address to a network device on the intranet 1. This DHCP server 20 can provide an IP address to a network device in the same segment but not to a network device in another segment. That is, the DHCP server 20 cannot provide an IP address to a network device across the router.

The agent 30 is a server that provides a fixed IP address to the image-processing device 10. More specifically, the agent 30 communicates with the image-processing device 10, to which a temporary IP address is assigned, and assigns a fixed IP address to the image-processing device 10. This means that the agent 30, which can provide an IP address across the router, may be in the same segment where the image-processing device 10 is present or in another segment. The agent 30 may be implemented, for example, by a personal computer (PC) or a specific image-processing device 10.

The intranet 1 is connected to the Internet 2 via a proxy server 40. A portal-service-providing server 50 that provides the portal service and a service-providing server 60 that provides services to the image-processing devices 10 are on the Internet 2. The services provided by the service-providing server 60 include, for example, a service that receives a scanned document from the image-processing device 10 and saves the received document.

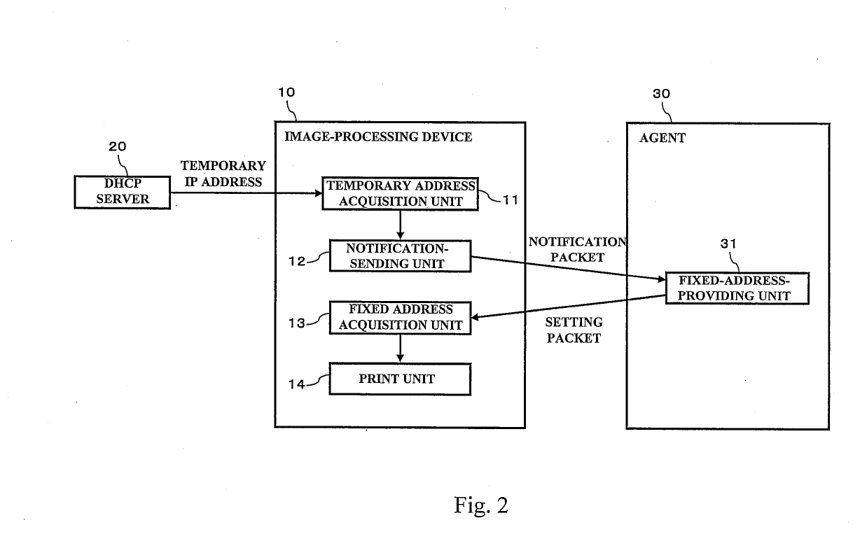

FIG. 2 is a block diagram showing the functional configuration of the image-processing device 10 and the agent 30. With reference to FIG. 2, the following describes the functional configuration of the image-processing device 10 and that of the agent 30.

The image-processing device 10 has a temporary address acquisition unit 11, a notification-sending unit 12, a fixed address acquisition unit 13, and a print unit 14.

The temporary address acquisition unit 11 acquires a temporary address from an address assignment device. More specifically, the temporary address acquisition unit 11 acquires a temporary IP address from the DHCP server 20 in the same segment as that of the image-processing device 10 according to the well-known DHCP protocol.

The notification-sending unit 12 sends a notification, which includes the temporary address acquired by the temporary address acquisition unit 11, to the network-setting device. More specifically, the notification-sending unit 12 sends a notification packet, whose source address is the temporary IP address acquired by the temporary address acquisition unit 11, to the agent 30.

The fixed address acquisition unit 13 acquires a fixed address, which is to be assigned to the image-processing device 10, from the network-setting device that sends this fixed address in response to the notification from the notification-sending unit 12. More specifically, the fixed address acquisition unit 13 acquires a fixed IP address, which is to be assigned to the image-processing device 10, from the agent 30 that sends this fixed address in response to the notification packet from the notification-sending unit 12. In this exemplary embodiment, the fixed address acquisition unit 13 acquires from the agent 30 not only the fixed IP address, but also the setting information required for connecting to the service providing server 60 on the Internet 2. The setting information includes the network setting information, such as a subnet mask and a default gateway address, as well as Internet connection information such as the address of the proxy server and the service URL (address information on the service-providing server 60).

The print unit 14 prints information indicating that the fixed address is acquired from the network-setting device when it is acquired. In this exemplary embodiment, the print unit 14 prints information indicating that the fixed IP address and the setting information described above are acquired from the agent 30 when they are acquired. The print unit 14 may also print information indicating that the setting is completed when the setting of the fixed address is completed or the setting of the setting information described above is completed in the image-processing device 10.

The agent 30 has a fixed-address-providing unit 31. In response to the notification described above, the fixed-address-providing unit 31 provides a fixed address, which is to be assigned to the image-processing device 10, to the image-processing device 10 identified by the temporary address included in the notification. More specifically, in response to the notification packet described above, the fixed-address-providing unit 31 provides a fixed IP address, which is to be assigned to the image-processing device 10, to the image-processing device 10 identified by the source address of the notification packet.

The above-described functions of the image-processing device 10 and the agent 30 are implemented, for example, by reading computer programs from a recording medium, such as a ROM (Read Only Memory) or a hard disk, into the main memory for execution by a CPU (Central Processing Unit). The programs may also be distributed either on a recording medium such as a CD-ROM or via the network. The function of the devices 10 and 30 described above may also be implemented, in part or in whole, by some other configuration such as a dedicated hardware device.

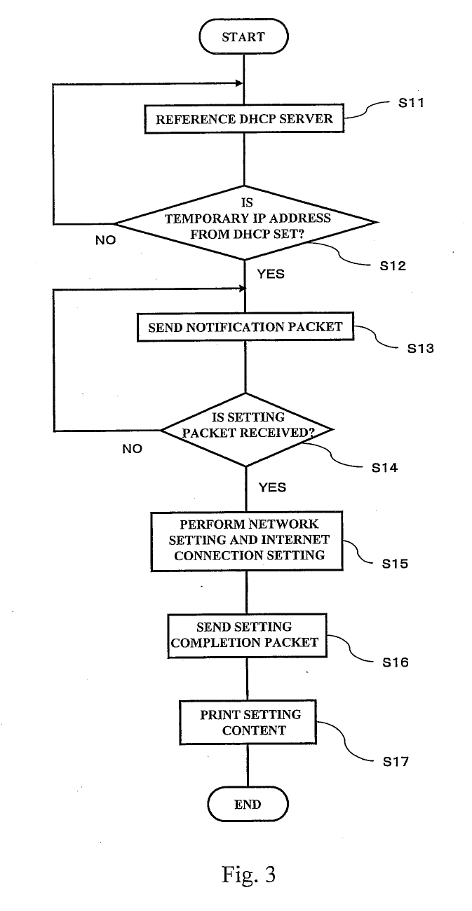

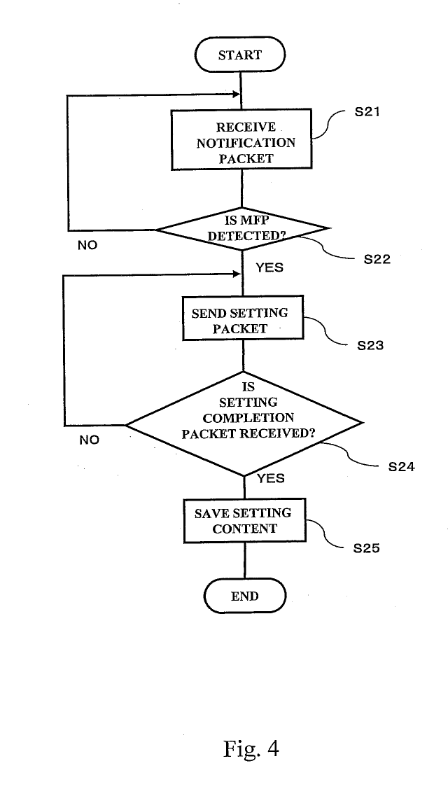

FIG. 3 is a flowchart showing the operation procedure of the image-processing device 10. FIG. 4 is a flowchart showing the operation procedure of the agent 30. With reference to FIGS. 3 and 4, the following describes the operation of the image-processing device 10 and that of the agent 30.

As shown in FIG. 3, the image-processing device 10, which operates in the IP address automatic setting mode of DHCP, references the DHCP server 20 (S11). More specifically, the image-processing device 10 acquires a temporary IP address from the DHCP server 20, installed in the same segment, according to the DHCP protocol and sets the acquired temporary IP address therein. At this time, the image-processing device 10 may also acquire from the DHCP server 20 not only the IP address, but also other setting information (subnet mask, default gateway address, etc.), required for connection to the intranet 1, and set the acquired information therein.

If the temporary IP address is set (S12: YES), the image-processing device 10 sends a notification packet, whose source address is the temporary IP address described above, to the agent 30 (S13). In this exemplary embodiment, the notification packet includes a serial number that serves as identification information for identifying the image-processing device 10.

In this case, the image-processing device 10 sends the notification packet to the agent 30 in one of several ways. For example, the image-processing device 10 uses SLP (Service Location Protocol) or, with the address of the agent 30 registered in the LDAP (Lightweight Directory Access Protocol) server, the image-processing device 10 inquires of the LDAP server about the address of the agent 30. SLP, a multicast protocol, controls TTL (Number of hops: Time To Live) to control the transmission range of the notification packet.

As shown in FIG. 4, the agent 30 receives the notification packet (S21) and, if the image-processing device 10 (MFP: Multi Function Peripheral) is detected (S22: YES), provides the network-setting information and the Internet connection setting information to the detected-image processing device 10 (S23). More specifically, the agent 30 sends a setting packet, which includes the network-setting information and the Internet connection setting information, to the image-processing device 10 with the source address (temporary IP address) of the received notification packet as the destination address.

The network-setting information includes at least the fixed IP address to be set in the image-processing device 10 and may include the subnet mask and the default gateway address. The Internet connection setting information includes the service URL, which is the address information on the service-providing server 60, and the proxy server setup information. The service URL and the proxy server setup information are set in the agent 30 in advance, for example, by the manager. Note that, because the service URL may be changed, it is possible to configure the system in such a way the agent 30 performs regular polling to acquire the latest service URL from the service-providing side (for example, the portal-service-providing server 50).

As shown in FIG. 3, if the setting packet described above is received (S14: YES), the image-processing device 10 performs the network setting and the Internet connection setting on the basis of the network setting information and the Internet connection setting information included in the setting packet (S15). More specifically, the image-processing device 10 sets the fixed IP address, sets the subnet mask, and sets the default gateway to perform the network setting. The image-processing device 10 also sets the service URL and sets the proxy server to perform the Internet connection setting. This setting allows the image-processing device 10 to connect to the service-providing server 60.

Once the setting described above is completed, the image-processing device 10 sends a setting completion packet, which indicates that the setting is completed, to the agent 30 (S16) and prints the setting content (fixed IP address that is set, etc.) (S17).

A shown in FIG. 4, if the setting completion packet described above is received (S24: YES), the agent 30 associates the serial number of the image-processing device 10, included in the notification packet received in step S21, with the fixed IP address provided to the image-processing device 10 in step S23 and saves the associated information therein (S25). At this time, the agent 30 may associate other network setting information and the Internet connection setting information, both of which are provided in step S23, with the serial number and save the associated information.

Although the agent 30 automatically sends the setting packet in response to the notification packet in the above description, the agent 30 may also send the setting packet in response to the operation of the user such as the manager. For example, the agent 30 may perform the operation as follows. In response to the notification packet, the agent 30 displays a device icon, which represents the image-processing device 10 from which the packet was sent, on the manager screen. When a setting icon, which represents the network-setting information or the Internet connection information, is dragged and dropped onto the device icon described above on the manager screen, the agent 30 sends a setting packet, which includes the setting information corresponding to the setting icon, to the image-processing device 10 corresponding to the device icon.

Although in the above description the TCP/IP network is used as the example of the network, another type of network may also be used.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The exemplary embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

For example, the network system 100 described above may be configured as in (a)-(f).

(a) The agent 30 has the function of managing the IP addresses of the image-processing devices 10 on the intranet 1. In this case, although the manager can manually enter unassigned fixed IP addresses into the agent 30, the agent 30 may regularly inquire of the server, such as the DNS (Domain Name System) server that manages IP addresses, about unassigned addresses for management.

(b) The agent 30 has the function of changing the IP address of the image-processing device 10 according to the onscreen operation performed by the manager. More specifically, the icons of the image-processing devices 10 to which fixed IP addresses are already assigned, as well as the icons of unassigned fixed IP addresses, are displayed on the screen of the agent 30. On this screen, when the icon of an unused fixed IP address is dragged and dropped onto the icon of the image-processing device 10 to which a fixed IP address is already assigned, the agent 30 communicates with the image-processing device 10 in response to the operation to change the fixed IP address of the image-processing device 10.

(c) The agent 30 has the network information management function of the DNS server and other servers.

(d) When the IP addresses assigned by the DHCP server 20 are exhausted or the fixed IP addresses are exhausted, the agent 30 issues a message indicating the condition. For example, the agent 30 displays the popup screen to display a message, or sends a message to the manager, to indicate the condition. When the fixed IP addresses are exhausted, the agent 30 may blink red the icon of the image-processing device 10 to which a fixed IP address is not assigned.

(e) When the IP addresses are exhausted and a temporary IP address is not assigned by the DHCP server 20, the image-processing device 10 notifies the user of the condition. For example, the image-processing device 10 outputs an error message on paper stating “Could not acquire IP address from DHCP server. Call network manager” or sends mail to the manager to indicate that an IP address could not be acquired from the DHCP server.

(f) When the fixed IP addresses are exhausted and a fixed IP address is not assigned by the agent 30, the image-processing device 10 notifies the user of the condition. For example, the image-processing device 10 outputs an error message on paper stating “Could not acquire fixed IP address. Call network manager” or sends mail to the manager to indicate that a fixed IP address could not be acquired.

What is claimed is:

1. A network system comprising:
a terminal on a network, and a network-setting device, wherein
the terminal comprises:
a temporary address acquisition unit that acquires a temporary address from an address assignment device;
a notification sending unit that sends a notification, including the acquired temporary address, to the network-setting device; and
a fixed address acquisition unit that acquires a fixed address to be assigned to the terminal, the fixed address being provided by the network-setting device in response to the notification, and
the network-setting device comprises a fixed-address-providing unit that provides the fixed address, which is to be assigned to the terminal, to the terminal identified by the temporary address included in the notification in response to the notification.

2. The network system according to claim 1, wherein
the terminal is an image-processing device, the terminal further comprising a print unit that, when the fixed address is acquired from the network-setting device, prints information indicating that the fixed address is acquired.

3. A network system comprising:
a network terminal, and a network-setting device, wherein
the network terminal comprises:
a temporary address acquisition unit that acquires a temporary IP (Internet Protocol) address from a DHCP (Dynamic Host Configuration Protocol) server;
a notification-sending unit that sends a notification packet, whose source address is the acquired temporary IP address, to the network-setting device; and
a fixed address acquisition unit that acquires a fixed IP address to be assigned to the terminal, the fixed IP address being provided by the network-setting device in response to the notification packet, and
the network-setting device comprises a fixed-address-providing unit that, in response to the notification packet, provides the fixed IP address, which is to be assigned to the terminal, to the terminal identified by the source address included in the notification packet.

4. The network system according to claim 3, wherein
the fixed address acquisition unit acquires not only the fixed IP address but also setting information, used to connect to a predetermined server on the Internet, from the fixed-address-providing unit.

5. The network system according to claim 4, wherein
the network terminal is an image-processing device, the terminal further comprising a print unit that, when the fixed address and the setting information are acquired from the network-setting device, prints information indicating that the fixed address and the setting information are acquired.

6. An image-processing device comprising:
a temporary address acquisition unit that acquires a temporary address from an address assignment device;
a notification-sending unit that sends a notification, including the acquired temporary address, to a network-setting device;
a fixed address acquisition unit that acquires a fixed address to be assigned to the image-processing device, the fixed address being provided by the network-setting device in response to the notification; and
a print unit that outputs information indicating that the fixed address is acquired.

7. A method of acquiring a fixed address to be assigned to a terminal on a network, comprising:
acquiring a temporary address from an address assignment device;
sending a notification, including the acquired temporary address, to a network-setting device; and
acquiring a fixed address to be assigned to the terminal, the fixed address being provided by the network-setting device in response to the notification.

8. The method according to claim 7, wherein
the terminal is an image-processing device,
the method further comprising, when the fixed address is acquired from the network-setting device, printing information in the image-processing device to indicate that the fixed address is acquired.

9. A computer readable medium storing a program causing a computer to execute a process for acquiring a fixed address to be assigned to a terminal on a network, the process comprising:
acquiring a temporary address from an address assignment device;
sending a notification, including the acquired temporary address, to a network-setting device; and
acquiring a fixed address to be assigned to the terminal, the fixed address being provided by the network-setting device in response to the notification.

10. The computer readable medium according to claim 9, wherein
the terminal is an image-processing device,
the process further comprises, when the fixed address is acquired from the network-setting device, printing information in the image-processing device to indicate that the fixed address is acquired.

11. A computer data signal embodied in a carrier wave for enabling a computer to perform a process for acquiring a fixed address to be assigned to a terminal on a network, the process comprising:
acquiring a temporary address from an address assignment device;
sending a notification, including the acquired temporary address, to a network-setting device; and
acquiring a fixed address to be assigned to the terminal, the fixed address being provided by the network-setting device in response to the notification.

12. The computer data signal according to claim 11, wherein
the terminal is an image-processing device,
the process further comprises, when the fixed address is acquired from the network-setting device, printing information in the image-processing device to indicate that the fixed address is acquired.

13. A network-setting device that performs network setting of a terminal on a network, comprising:
an acceptance unit that accepts a notification, including a temporary address acquired by the terminal from an address assignment device, from the terminal; and
a fixed address providing unit that provides network-setting information, including a fixed address, to the terminal to allow the terminal to perform network setting on the basis of the network-setting information.
